(19) United States
(12) Patent Application Publication
(10) Pub. No.: US 2008/0127037 A1
(43) Pub. Date: May 29, 2008

(54) System and method for detecting software on a computing device

(76) Inventors: Prashanth Kadur, Coram, NY (US); James Fagioli, Holtsville, NY (US)

Correspondence Address: FAY KAPLUN & MARCIN, LLP, 150 BROADWAY, SUITE 702, NEW YORK, NY, 10038, US

(21) Appl. No.: 11/581,968

(22) Filed: Oct. 16, 2006

(51) Int. Cl. G06F 9/44

(52) U.S. Cl. 717/100; 717/126

(57) ABSTRACT

Described is an application development tool, system and method for detecting software on a computing device. The application development tool comprises an application development element for developing at least a portion of an application, and a receiving element receiving software data of a target device on which the application will be executed. The application development element analyzes code in the portion of the application as a function of the software data.

### FIELD OF THE INVENTION

The present invention relates generally to systems and methods for detecting software on a computing device.

### BACKGROUND

A conventional software application development tool, such as an Integrated Development Environment (IDE), is a programming environment that includes components such as a graphical user interface (GUI) builder, a text/code editor, a compiler or interpreter and a debugger. Application developers use the components of the IDE to create software applications for computing devices. While coding the application, the developer may refer to a help file to learn about software on the computing device. However, the help file typically contains information about a range of products and software packages, and the developer must sift through this information to find the particular information of interest. Also, if the developer uses the wrong information (e.g., a different operating system, etc.), the application may be incompatible with the computing device. Thus, a significant amount of time may be wasted in manually searching the help file and/or correcting a developed application.

### SUMMARY OF THE INVENTION

The present invention relates to an application development tool, system and method for detecting software on a computing device. The application development tool comprises an application development element for developing at least a portion of an application, and a receiving element receiving software data of a target device on which the application will be executed. The application development element analyzes code in the portion of the application as a function of the software data.

### DESCRIPTION OF THE DRAWINGS

FIG. 1 shows an exemplary embodiment of a system according to the present invention.

FIG. 2 shows an exemplary embodiment of a method according to the present invention.

FIG. 3a shows an exemplary embodiment of a code editor of an IDE according to the present invention.

FIG. 3b shows an exemplary embodiment of a code editor of an IDE analyzing code according to the present invention.

### DETAILED DESCRIPTION

The present invention may be further understood with reference to the following description and the appended drawings, wherein like elements are referred to with the same reference numerals. The present invention describes an application development tool, a system and a method for detecting software installed on a computing device. In the exemplary embodiments, a host device executes an application development tool that detects all or selected portions of the software installed on a target device. The application development tool then monitors code written by a developer and determines whether the code is supported by the software on the target device. While the exemplary embodiments are described with reference to generating an application for a mobile computing device, those of skill in the art will understand that the present invention may be used to design any type of software application for any type of computing device.

The exemplary embodiments of the present invention may be implemented as an IDE or as an extension to an existing IDE. In the latter case, the present invention may be provided as a plug-in, allowing the existing IDE to detect the software on a computing device. The plug-in may be one of a plurality of plug-ins provided in a software kit for use with the existing IDE.

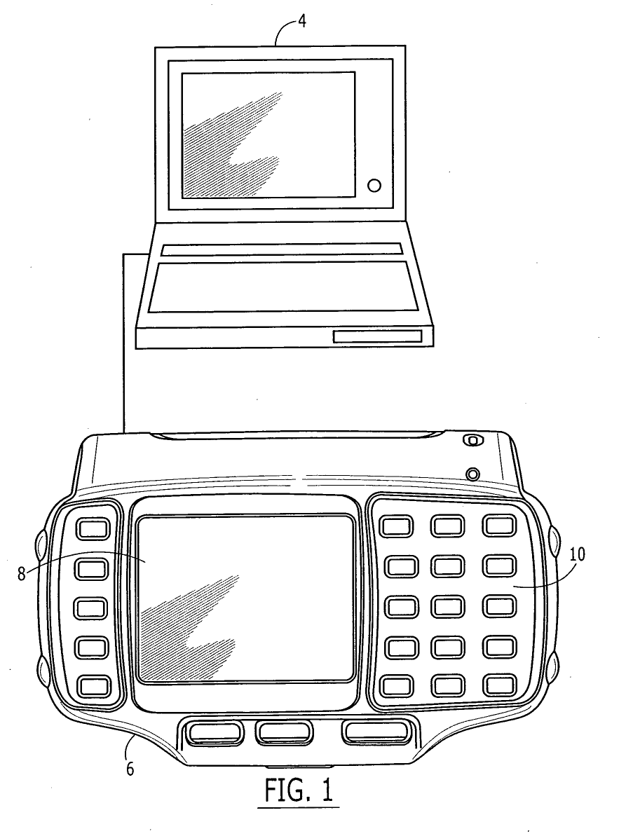

FIG. 1 shows an exemplary embodiment of a system 2 according to the present invention. The system 2 includes a host computing device 4 which is used to create a software application for a target computing device 6. The host device 4 may be a PC, laptop, tablet computer, etc. which uses an IDE or other application development tool to create the software application. The target device 6 may be a mobile computing device such as an imager-/laser-based scanner, an RFID reader, a mobile phone, a PDA, a tablet computer, a laptop, a digital camera, a portable media player, a smart appliance, etc. In other exemplary embodiments, the target device 6 may be a PC, a copier, a fax machine, a printer or other stationary workstation. The IDE provides a set of application development elements including, for example, a graphical user interface (GUI) builder, a code editor, a compiler or interpreter and a debugger. As known by those of skill in the art, the code editor is a platform allowing the developer to input software code that may be compiled into a software application and/or stored as a construct/snippet.

In the exemplary embodiment, when the developer is creating an application, the target device 6 is coupled to the host device 4, and the IDE on the host device 4 detects software data of the target device 6 via a receiving element (e.g., software for a hard/soft port). The software data may identify system software (e.g., an application programming interface (API), operating system, device drivers, diagnostic tools, utilities, etc.) and/or application software (e.g., application suites, individual programs, updates, etc.) installed on the target device 6. The software data may further include customizations and/or settings for the system/application software, as well as any other data related to the software that is stored in a memory of the target device 6 and/or a peripheral device (e.g., memory card/stick) coupled thereto. As will be explained further below, the IDE may monitor input to the code editor to determine, based on the software data, whether the input is supported by the software on the target device 6.

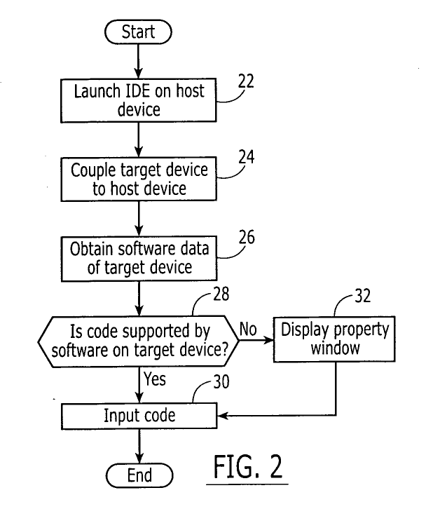

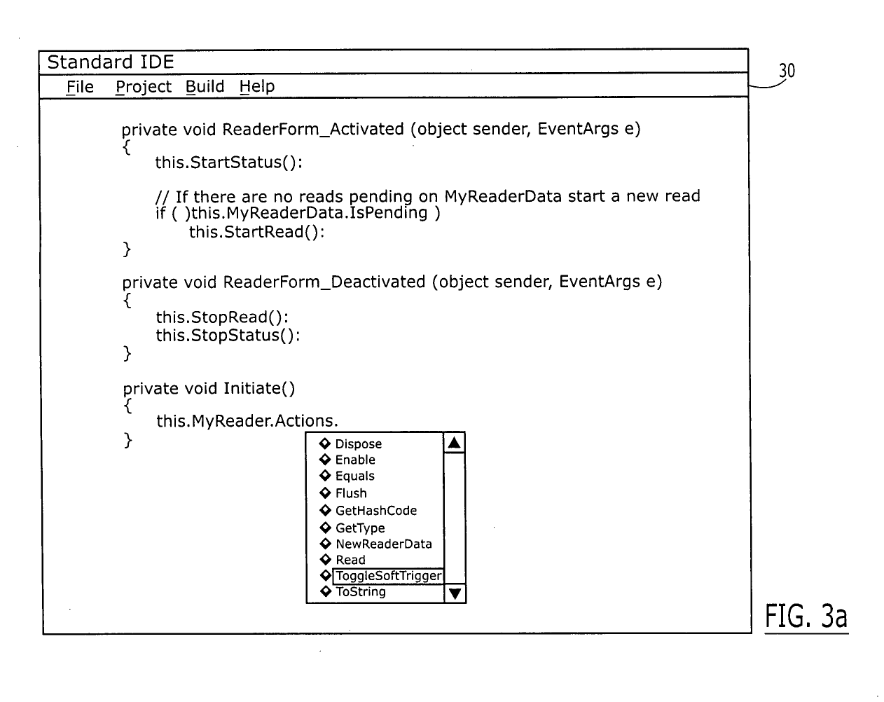

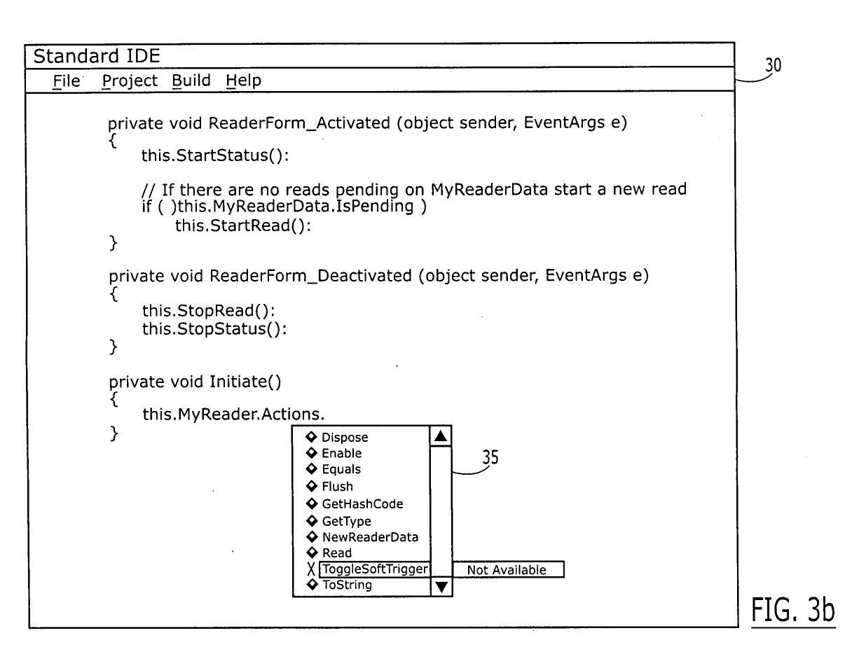

FIG. 2 shows an exemplary embodiment of a method 20 according to the present invention. In step 22, the IDE is launched on the host device 4. The IDE may be initially configured (e.g., by the manufacturer thereof) with first software data which corresponds to a predetermined set of system and/or application software. FIG. 3a shows an exemplary embodiment of a code editor 30 of the IDE used by the developer to input the software code that comprises the application.

In step 24, the target device 6 is coupled to the host device 4 via a wired or wireless connection. As shown in FIG. 1, a cable (e.g., serial, USB, etc.) may interconnect respective ports on the host and target devices 4 and 6. In another exemplary embodiment, the host device 4 may establish a wireless connection with the target device 6 via, for example, wireless communication devices (e.g., Bluetooth® or IEEE 802.11 radios) in the host and target devices 4 and 6.

In step 26, the host device 4 obtains the software data of the target device 6. In the exemplary embodiment, the host device 4 downloads (or the target device 6 uploads) the hardware data over the wired or wireless connection. The host device 4 may include an application or applet for interrogating the target device 6 to which the target device 6 responds with the software data. In another embodiment, the host device 4 may search for the software data in one or more predetermined locations, e.g., ROM, RAM, caches, buffers, storage devices coupled to the target device 6, etc. In a further embodiment, the target device 6 may store the software data in memory (or other location/device) and transmit the software data upon being connected to the host device 4.

In another exemplary embodiment, the target device 6 may include a barcode(s) and/or RFID tag which stores the software data. The host device 4 (or a data capture device coupled thereto) obtains the software data by decoding the barcode(s) and/or interrogating the RFID tag. As understood by those of skill in the art, in this embodiment, the host device 4 need not be coupled to the target device 6 and step 24 may be skipped. The barcode or tag may include identification data (e.g., the serial number) of the target device 6 which may be used to lookup the software data in a database. For example, the host device 4 may obtain the software data from a site (e.g., server, database, etc.) on a communications network (e.g., intranet, the Internet, etc.) using the identification data. In this embodiment, the target device 6 may be coupled to a charging device which is connected to the communications network. The target device 6 may upload the software data to the site each time it is coupled to the charging device so that the software data is continually updated at the site. Thus, the developer may create an application for the target device 6 when the host device 4 is remote therefrom by connecting to the site over the communications network.

In step 28, the IDE determines, based on the software data, whether code input by the developer is supported by the software on the target device 6. As shown in FIG. 3a, the developer has input the code ‘this.MyReader.Actions’ into the code editor 30. The developer may be creating an application which utilizes, for example, an RFID reader coupled to the target device 6. The IDE may analyze the code that executes a call to code in the target device for operating the RFID reader and determine one or more properties which can be associated with the code based on the software data. For example, as shown in FIG. 3b, when the IDE detects the code for the RFID reader, a property window 35 including a list of one or more properties supported by the software on the target device 6 may be displayed in the code editor 30. In one exemplary embodiment, the properties which are supported by the target device 6 may be highlighted (or otherwise indicated as selectable) in the property window 35, while the properties which are not supported may be grayed (or otherwise indicated as unselectable) in the property window 35. Based on the software data, the property ‘ToggleSoftTrigger’ may not be supported, because the target device 6 may not utilize a soft trigger (e.g., a touch screen), but rather uses a mechanical trigger to initiate a read of an RFID tag. Thus, the target device 6 may not have software to support input entered via a soft trigger.

Those of skill in the art will understand that the properties may be added to and/or removed from the property window 35 based on the software data. For example, in another exemplary embodiment, the property window 35 may only display properties which are supported by the software on the target device 6. This ensures that the developer will not choose an unsupported property.

In another exemplary use, the code input by the developer may indicate that the RFID reader should interrogate a particular type of RFID tag, e.g., a Gen2 tag. However, the software data may indicate that a tag reading application(s) on the target device 6 does not read Gen2 tags. The IDE detects the code related to reading the Gen2 tag, and outputs an indication that the code is unsupported by the software on the target device 6.

In a further exemplary embodiment, the IDE may analyze the software data to determine an operating system on the target device 6. For example, if Windows Mobile 5.0 is installed on the target device 6, the IDE may reconfigure one or more settings, tools, editors, compiler, debuggers, etc. for creating an application for Windows Mobile 5.0. In this embodiment, the IDE ensures that the application is compatible with the operating system (and version) on the target device 6.

In step 30, the code input by the developer is supported by the software on the target device 6 and is input into the application.

In step 32, the code is not supported by the software on the target device 6, so the IDE may output a response based on the software data. For example, the IDE may output a message indicating that the code and/or the property is not supported by the software on the target device 6. The message may further include an alternative suggestion indicative of a code/property providing a similar functionality and that is supported by the software on the target device 6. Using the above example, the alternative suggestion may include highlighting a ‘ToggleHardTrigger’ property because the software data indicates that the target device 6 utilizes software that interprets movement of a mechanical trigger. Thus, the IDE may analyze the code being input by the developer and provide suggestions for additional code and/or properties associated with the code based on the software data.

In another exemplary embodiment, the software data obtained from the target device 6 may be used to generate a software profile thereof. The software profile may then be stored in a database (e.g., memory of the host device 4, an FTP site, a server, etc.) for subsequent use by the host device 4 or other host devices. For example, an application developer may search the database for the software profile of the target device 6 prior to connecting to and obtaining the software data directly from the target device 6. If the software profile is located in the database, it may be downloaded and used by the IDE to monitor code input by the developer. Thus, the developer may not be required to obtain the software data from the target device 6 when the software profile thereof is available in the database. In a further exemplary embodiment, the software data may be contained in a storage medium (e.g., floppy or zip disk, CD, DVD, memory stick, etc.) which, for example, comes packaged with the target device 6.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An application development tool, comprising:
an application development element developing at least a portion of an application; and
a receiving element receiving software data of a target device on which the application will be executed,
wherein the application development element analyzes code in the portion of the application as a function of the software data.

2. The tool according to claim 1, wherein the software data is indicative of software installed on the target device.

3. The tool according to claim 2, wherein the software includes at least one of system software and application software.

4. The tool according to claim 3, wherein the system software is an operating system.

5. The tool according to claim 1, wherein the application development element includes a code editor displaying the code in the portion of the application.

6. The tool according to claim 1, further comprising:
a display window displaying at least one property associated with the code in the portion of the application.

7. The tool according to claim 6, wherein each of the at least one property is associated with a corresponding executable property included in the software data.

8. The tool according to claim 6, wherein the display window highlights selected ones of the at least one property only when the selected property is associated with a corresponding executable property included in the software data.

9. A method, comprising:
obtaining software data of a target device, the software data indicative of software utilized by the target device; and
analyzing user input as a function of the software data, the user input including software code creating a software application for the target device.

10. The method according to claim 9, wherein the analyzing includes:
determining if the target device supports the software code by comparing the software code to the software data.

11. The method according to claim 10, further comprising:
when a property in the software code does not match an executable property in the software data, displaying a warning message.

12. The method according to claim 9, wherein the obtaining step includes:
establishing a wired connection with the target device; and
downloading the software data via the wired connection.

13. The method according to claim 9, wherein the obtaining step includes:
establishing a wireless connection with the target device; and
downloading the software data via the wireless connection.

14. The method according to claim 9, wherein the obtaining step includes:
downloading a profile of the target device from a database, the profile including the software data.

15. The method according to claim 9, wherein the software includes at least one of system software and application software.

16. A system, comprising:
a target device having software installed thereon; and
a host device creating an application to be executed on the target device using an application development tool, the host device obtaining software data of the target device indicative of the software installed thereon and analyzing software code input to the application development tool as a function of the software data.

17. The system according to claim 16, wherein the host device determines whether the target device supports the software code input by comparing the software code to the software data.

18. The system according to claim 17, wherein, when a property in the software code does not match an executable property in the software data, the host device displays a warning message.

19. The system according to claim 18, wherein the warning message includes at least one executable property in the software data corresponding to the software code.

20. The system according to claim 17, further comprising:
a database storing a plurality of profiles corresponding to a plurality of target devices, each profile including software data for a respective target device,
wherein the host device obtains a profile of the target device from the database, the profile including the software data.

21. An application development tool, comprising:
an application development means for developing at least a portion of an application; and
a receiving means for receiving software data of a target device on which the application will be executed,
wherein, the application development means analyzes code in the portion of the application as a function of the software data.
